(19) United States
(12) Patent Application Publication
(10) Pub. No.: US 2022/0405700 A1
(43) Pub. Date: Dec. 22, 2022

(54) PURCHASE FULFILLMENT USING MICRO WAREHOUSES

(71) Applicant: UNOECOM INC., Monmouth Junction, NJ (US)

(72) Inventor: Navdeep GADHOKE, Monmouth Junction, NJ (US)

(21) Appl. No.: 17/839,983

(22) Filed: Jun. 14, 2022

Related U.S. Application Data
(60) Provisional application No. 63/211,066, filed on Jun. 16, 2021.

(51) Int. Cl. G06Q 10/08; G06Q 30/06

(52) U.S. Cl. CPC G06Q 10/087; G06Q 10/083; G06Q 30/0641

(57) ABSTRACT

Aspects of the present disclosure include methods, apparatuses, and computer readable media for processing a purchase order including receiving the order for the purchase from a purchaser, identifying a micro warehouse storing a product in the order, the micro warehouse being a non-commercial storage facility, and transmitting an instruction to a system associated with the micro warehouse instructing a shipment of the product to an address of the purchaser.

### CROSS REFERENCE TO RELATED APPLICATIONS

The current application claims priority to, and the benefit of, U.S.

Provisional Application No. 63/211,066 filed on Jun. 16, 2021, and entitled “PURCHASE FULFILLMENT USING MICRO WAREHOUSES,” the contents of which are hereby incorporated by reference in its entirety.

### TECHNICAL FIELD

The present disclosure relates to distributed micro warehousing.

### BACKGROUND

Online shopping offers the advantage of convenience, lower cost, and a large selection of sellers and/or products. Further, in times of crises such as an epidemic, online shopping provides the necessary social distancing for reducing physical contacts. In conventional online shopping schemes, after a customer buys a product from an online store, the online store locates the purchased product stored a commercial warehouse, and ships the purchased product from the commercial warehouse to a destination indicated by the customer. However, commercial warehouses may be expensive to own, rent, maintain, and/or manage. Further, given the costs associated with using commercial warehouses for storage, an online store may be limited to a number of commercial warehouses in a given region, potentially increasing delivery times for destinations far (e.g., more than 50 miles, 100 miles, or 200 miles) away from the commercial warehouses. Therefore improvements may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include methods, apparatuses, and computer readable media for processing a purchase order including receiving the order for the purchase from a purchaser, identifying a micro warehouse storing a product in the order, wherein the micro warehouse is a non-commercial storage facility, and transmitting an instruction to a system associated with the micro warehouse instructing a shipment of the product to an address of the purchaser.

### BRIEF DESCRIPTION OF THE DRAWINGS

The novel features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of an environment for implementing distributed micro warehouses in accordance with aspects of the present disclosure;

FIG. 2 illustrates an example of an algorithm for fulfilling an order in accordance with aspects of the present disclosure;

FIG. 3 illustrates an example of an algorithm for generating shipping labels in accordance with aspects of the present disclosure;

FIG. 4 illustrates an example of an algorithm for selecting a shipper in accordance with aspects of the present disclosure;

FIG. 5 illustrates a first example of an algorithm for micro warehouse distribution in accordance with aspects of the present disclosure;

FIG. 6 illustrates a second example of an algorithm for distribution in accordance with aspects of the present disclosure;

FIG. 7 illustrates an example of a diagram for deploying micro warehousing in accordance with aspects of the present disclosure;

FIG. 8 illustrates an example of a diagram showing two dot zip codes in accordance with aspects of the present disclosure;

FIG. 9 illustrates an example of a method for processing a purchase order in accordance with aspects of the present disclosure;

FIG. 10 illustrates another example of a method for processing a purchase order in accordance with aspects of the present disclosure;

FIG. 11 illustrates an example of a method for distributing products in accordance with aspects of the present disclosure;

FIG. 12 illustrates an example of a computer system in accordance with aspects of the present disclosure; and

FIG. 13 illustrates a block diagram of various example system components in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein.

The term “bus,” as used herein, can refer to an interconnected architecture that is operably connected to transfer data between computer components within a singular or multiple systems. The bus can be a memory bus, a memory controller, a peripheral bus, an external bus, a crossbar switch, and/or a local bus, among others. The bus can also be a bus that interconnects components such as Controller Area network (CAN), Local Interconnect Network (LIN), among others.

The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

The term “operable connection,” as used herein, can include a connection by which entities are “operably connected”, is one in which signals, physical communications, and/or logical communications can be sent and/or received. An operable connection can include a physical interface, a data interface and/or an electrical interface.

An aspect of the present disclosure provides a portal for sellers to sell products (also referred to interchangeably herein as merchandise) that are stored in micro warehouses and/or distribution center warehouses (e.g., commercially managed warehouses). Micro warehouses may include patios, attics, basements, or other storage locations of single family homes, condominiums, apartments, public storage areas, and/or other non-commercially managed locations. Residents of the micro warehouses may sign up at the portal to stock products of the sellers. When a product is purchased, the resident of a warehouse selected for delivering the product may package, handle, arrange for shipping, and/or deliver the purchased product to a destination. The residents of the micro warehouses may receive incentives for storing and/or shipping the products.

In certain aspects, distribution center warehouses may be ranked by one or more factors such as cut-off timing, shipment, damage rate, loss rate, on time shipment rate, on time acknowledgement rate, cost rating, total space, used space, and/or available space. Micro warehouses may be ranked by one or more factors such as cut-off timing, shipment, damage rate, loss rate, on time shipment rate, on time acknowledgement rate, cost rating, score, total space, used space, and/or available space.

Aspects of the present disclosure may advantageously use spaces in homes to fulfill e-commerce orders and/or combining distributing units between warehouses (e.g., commercial distribution centers) and homes (e.g., micro warehouses). Another advantage of the present disclosure may include routing algorithms that store products closer to customers to reduce delivery time and/or costs. Aspects of the present disclosure may increase efficiency in fulfillment of e-commerce orders.

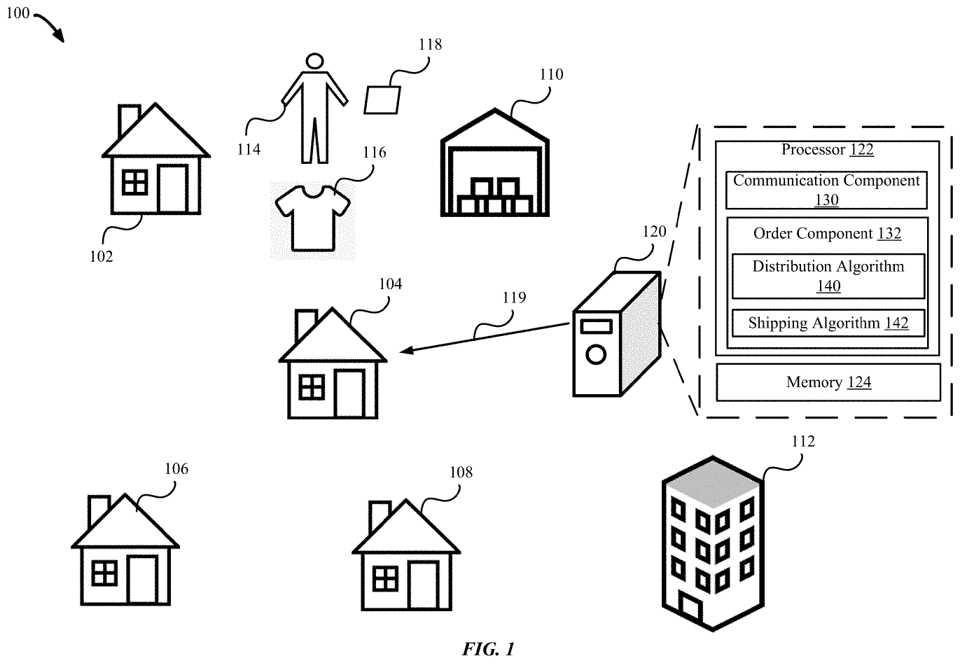

Turning to FIG. 1, in some aspects, a schematic view of an example of an environment 100 for implementing micro warehousing. In some implementations, the environment 100 may include a destination 102 associated with a customer 114. The environment 100 may include a company 112 selling merchandise 116. The environment 100 may include a first micro warehouse 104. The environment 100 may include a second micro warehouse 106. The environment 100 may include a third micro warehouse 108. The environment 100 may optionally include a commercial warehouse 110 associated with the company 112.

In certain implementations, the micro warehouses 104, 106, 108 may be non-commercial warehouses not used primarily as a storage of commercial products. For example, the micro warehouses 104, 106, 108 may be one or more of single family homes, apartments, garages, sheds, condominiums, basements, attics, and/or other personal storage spaces. The micro warehouses 104, 106, 108 may be allocated for storing merchandise of the company 112, and/or other companies.

In some instances, a server 120 may include a processor 122 and a memory 124. The server 120 may be hosted on one or more computing devices, in a cloud computing environment, and/or a combination thereof. The server 120 may be associated with the company 112, or offer subscriptions to the company 112 for using the techniques described in the present disclosure.

In an implementation, the processor 122 may include routines and/or algorithms for fulfilling purchase orders via one or more of the micro warehouses 104, 106, 108. The instructions for the routines may be stored in the memory 124 and/or any internal memory (e.g., levels 1, 2, and/or 3 cache memory) of the processor 122. The processor 122 may include a communication component 130 that transmits and/or receives communications signals with external devices via an optional communications device (discussed below). The communication component 130 of the processor 122 may receive updates from a remote server. The processor 122 may include an order component 132 configured to implement methods and/or algorithms for fulfilling purchase orders via the one or more of the micro warehouses 104, 106, 108. The order component 132 may include a distribution algorithm 140 configured to locate merchandise among warehouses. The order component 132 may include a shipping algorithm 142 configured to determine the shipping costs, the shipping methods, and/or the transit times associated with the deliveries the merchandise.

In optional variations, the server 120 may include an optional communications device (e.g., wireless modem, not shown) for providing wired or wireless computer communications utilizing various protocols to send/receive electronic signals internally with respect to features and systems within the server 120 and with respect to external devices. These protocols may include a wireless system utilizing RF communications (e.g., IEEE 802.11 (Wi-Fi), IEEE 802.15.1 (Bluetooth®)), a near field communication system (NFC) (e.g., ISO 13157), a local area network (LAN), a wireless wide area network (WWAN) (e.g., cellular) and/or a point-to-point system. Additionally, the communications device of the server 120 may be operably connected for internal computer communication via a bus (e.g., a CAN or a LIN protocol bus) to facilitate data input and output between among features and systems.

During normal operation, in an example implementation, the company 112 may register on the server 120. The company 112 may send (and/or arrange for the transportation of) merchandise, such as the merchandise 116, to one or more of the micro warehouses 104, 106, 108, and/or the commercial warehouse 110 for storage. The company 112 may attempt to sell the merchandise 116. The server 120 may store the locations of the merchandise in, for example, the memory 124. Alternatively or additionally, the server 120 may store the inventories of the micro warehouses 104, 106, 108, and/or the commercial warehouse 110. The micro warehouses 104, 106, 108, and/or the commercial warehouse 110 may be geographically located in different locations (e.g., blocks, towns, cities, counties, states, countries, etc.). The first micro warehouse 104 may be a garage. The second micro warehouse 106 may be a shed. The third micro warehouse 108 may be a basement.

In some implementations, the customer 114 may purchase the merchandise 116 online, or via other means (e.g., in person, over the phone, etc.), from the company 112 via the server 120 (and/or webpages hosted by the server 120). The server 120 may receive a purchase order 118 indicating the purchase of the merchandise 116. The purchase order 118 (digital or paper) may include delivery instructions to deliver the merchandise 116 to the destination 102 (e.g., home of the customer 114, home of a gift recipient, etc.). The distribution algorithm 140 and/or the server 120 may search the inventories of the micro warehouses 104, 106, 108, and/or the commercial warehouse 110 for the merchandise 116. The distribution algorithm 140 and/or server 120 may determine that the first micro warehouse 104 and the third micro warehouse 108 have the merchandise 116 in stock.

In an implementation, the shipping algorithm 142 and/or the server 120 may determine that the first micro warehouse 104 is closer to the destination 102 than the third micro warehouse 108. Alternatively or additionally, the shipping algorithm 142 may determine that a first shipping cost associated with shipping the merchandise 116 (or a first item of the merchandise 116) from the first micro warehouse 104 to the destination 102 may be lower than a second shipping cost associated shipping the merchandise 116 (or a second item of the merchandise 116) from the third micro warehouse 108 to the destination 102. As a result, the communication component 130 and/or the server 120 may transmit an indication 119 to a device (such as a computer, a mobile phone, etc.) associated with a person (not shown) managing the first micro warehouse 104. The indication 119 may include shipping instructions and/or labels to ship the first item of the merchandise 116 stored in the first micro warehouse 104 to the destination 102. The indication 119 may include merchandise information (e.g., size, color, material, and/or other attributes) associated with the merchandise 116. The indication 119 may include purchase information (e.g., quantity, cost, delivery fees, transaction fees, etc.) associated with the purchase order 118.

In certain implementation, the first person may arrange for the first item of the merchandise 116 to be shipped from the first micro warehouse 104 to the destination. In alternatively implementations, the communication component 130 and/or the server 120 may transmit the indication 119 to a delivery system that automatically delivers the first item of the merchandise 116.

In some implementations, the server 120 may host a number of companies that sell products online. The server 120 may track the inventories of a number of micro warehouses (each storing products of one or more companies).

In optional implementations, the distribution algorithm 140 and/or server 120 may determine that the first micro warehouse 104, the third micro warehouse 108, and the commercial warehouse 110 have the merchandise 116 in stock. The shipping algorithm 142 and/or the server 120 may determine that the first micro warehouse 104 and the commercial warehouse 110 are closer than the third micro warehouse 108. Alternatively or additionally, the shipping algorithm 142 may determine that a first shipping cost associated with shipping the merchandise 116 (or a first item of the merchandise 116) from the first micro warehouse 104 to the destination 102 is substantially similar to a third shipping cost associated with shipping the merchandise 116 (or a third item of the merchandise 116) from the commercial warehouse 110 to the destination 102. The server 120 may elect to ship from the first micro warehouse 104. The server 120 may offer a choice to the customer 114 (by displaying on a device used by the customer 114) to ship from the first micro warehouse 104 or the commercial warehouse 110. An incentive may be offered to the customer 114 (e.g., lower handling/delivery fees) to select the first micro warehouse 104.

In an aspect of the present disclosure, one or more of the first micro warehouse 104, the second micro warehouse 106, and/or the third micro warehouse 108 may store merchandise not offered by the company 112. For example, the one or more of the first micro warehouse 104, the second micro warehouse 106, and/or the third micro warehouse 108 may store merchandise selected, purchased, and/or stocked by the owners (not shown) of the first micro warehouse 104, the second micro warehouse 106, and/or the third micro warehouse 108. The merchandise may be displayed via a portal hosted by the server 120 for purchase by customers, such as the customer 114. In one example, the customer 114 may request to purchase one or more items of merchandise warehoused in the second micro warehouse 106 via the portal. After receiving the confirmation of payment associated with the merchandise, the owner of the second micro warehouse 106 may deliver the merchandise to a location designated by the customer 114. In another example, the customer 114 may request to purchase merchandise warehoused in the third micro warehouse 108 via the portal. After receiving the confirmation of payment associated with the merchandise, delivery personnel (not shown) may pick up the merchandise at the second micro warehouse 106 and deliver the merchandise to a location designated by the customer 114. Other aspects of displaying, selling, and delivering merchandise may also be implemented.

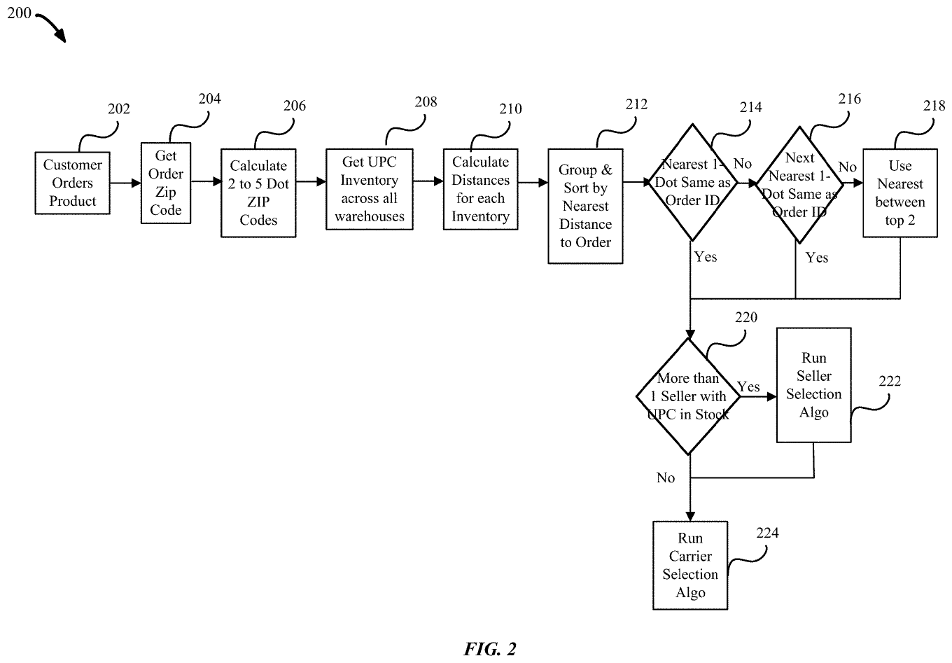

Turning now to FIG. 2, and referencing FIG. 1, in certain aspects, a method 200 of fulfilling an order may include, at 202, receiving an indication (such as the indication 119) that the customer (such as the customer 114) has ordered a product (such as the merchandise 116). At 204, the method 200 may obtain the destination zip code (e.g., 91745, interchangeably referred to herein as a postal code) indicated in the indication. At 206, the method 200 may calculate the 2 dot zip code (e.g., 91) of the destination zip code, the 3 dot zip code (e.g., 917) of the destination zip code, the 4 dot zip code (e.g., 9174) of the destination zip code, and/or the 5 dot zip code (e.g., 91745) of the destination zip code. At 208, the method 200 may obtain the universal product code (UPC) inventory information of the micro warehouses. At 210, the method 200 may calculate the distances between each of the warehouses having the ordered product and the destination. At 212, the method 200 may group and/or sort the distances.

In some instances, at 214, the method 200 may determine whether the 1 dot zip code of the nearest (in terms of distance) warehouse (or nearest group of warehouses) is the same as the 1 dot zip code of the destination. If no, at 216, the method 200 may determine whether the 1 dot zip code of the next nearest (in terms of distance) warehouse (or next nearest group of warehouses) is the same the 1 dot zip code of the destination. If no, at 218, the method 200 may use the nearest warehouse (or nearest group) between the two indicated above.

In some implementations, at 220 (if yes at 214 and/or 216, or after 218), the method 200 may determine if there is more than one seller with UPC in stock. If yes, at 222, the method 200 may execute the seller selection algorithm (described below). If no, at 224, the method 200 may execute the carrier selection algorithm (described below).

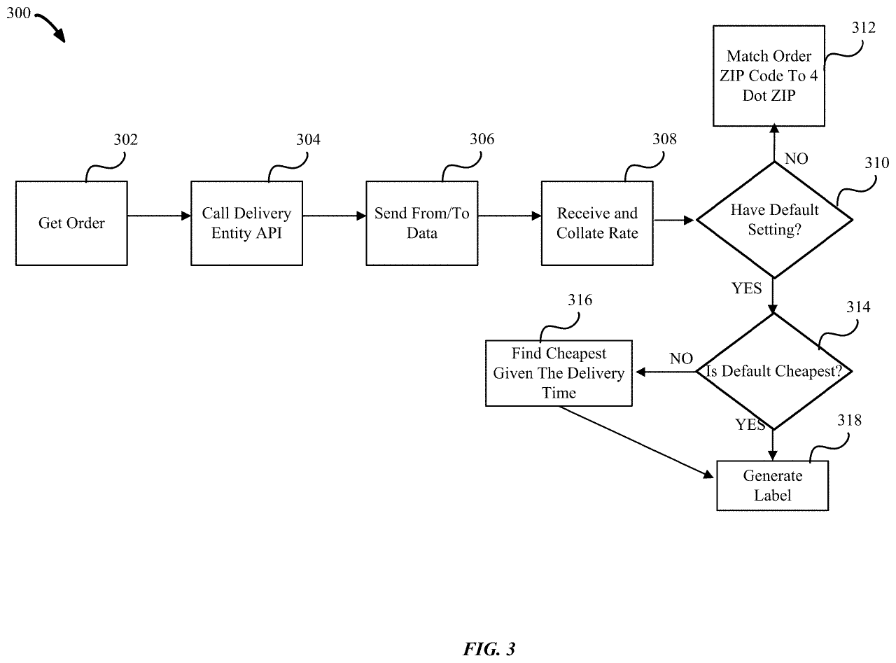

Turning now to FIG. 3, in certain aspects, a method 300 for generating shipping labels may, at 302, obtain the purchase order. At 304, the method 300 may call delivery entity application programming interface(s) (API(s)) of delivery entities (e.g., carrier services). At 306, the method 300 may transmit customer, source (e.g., micro warehouse), and/or destination information. At 308, the method 300 may receive and/or collate the rate(s) for the delivery. At 310, the method 300 may determine whether there is a default setting for the shipping label. If no, at 312, the method 300 may attempt to match the destination zip code to a 4 dot zip code of a warehouse delivering the product to determine the cost associated with the delivery associated with each of the delivery entities. If a default setting for the ship label exists, at 314, the method 300 may determine whether the default setting is the least expensive. If no, at 316, the method 300 may search for the least expensive delivery option given the delivery time. If yes, at 318, the method 300 may generate the label.

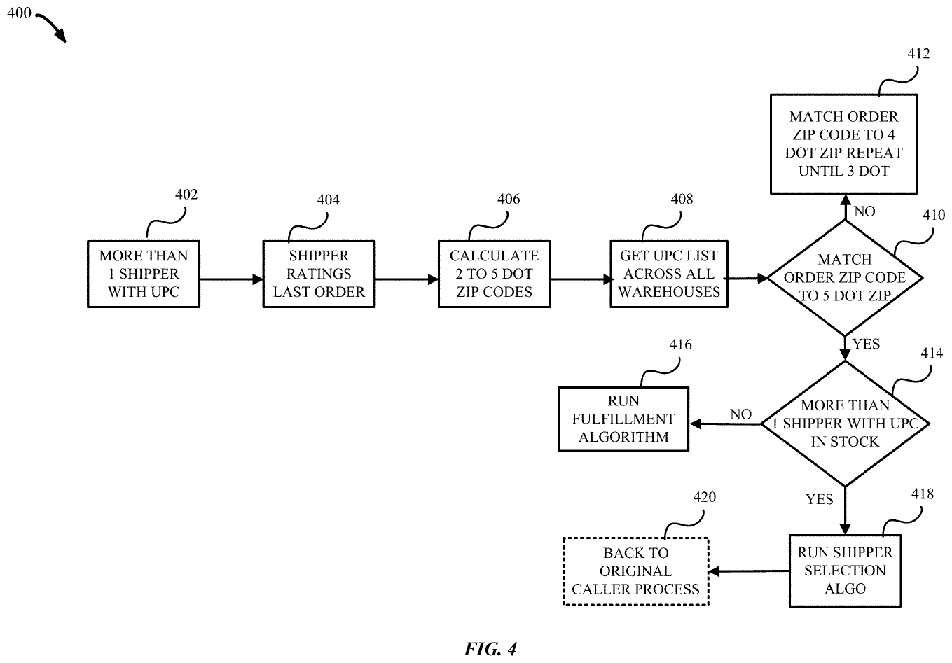

Turning now to FIG. 4, and referencing FIGS. 1 and 2, in certain aspects, a method 400 for selecting a shipper may, at 402, identify more than one shipper with the purchased product in the order. At 404, the method 400 may determine the ratings of the more than one shipper associated with previous orders. At 406, the method 400 may calculate the 2 dot zip code (e.g., 91) of the destination zip code, the 3 dot zip code (e.g., 917) of the destination zip code, the 4 dot zip code (e.g., 9174) of the destination zip code, and/or the 5 dot zip code (e.g., 91745) of the destination zip code. At 408, the method 400 may obtain the UPC inventory information of the micro warehouses. At 410, the method 400 may determine whether the destination zip code (or order zip code) matches the 5 dot zip code. If no, at 412, the method 400 may determine whether the destination zip code (or order zip code) matches the 4 dot zip code and/or the 3 dot zip code (if the destination zip code does not match the 4 dot zip code).

If the destination zip code (or order zip code) matches the 5 dot zip code, at 414, the method 400 may determine whether more than one shipper has the purchased product in stock (based on the UPC information). If no, at 416, the method 400 may execute a fulfillment algorithm, such as the algorithm shown in FIG. 2. If yes, at 418, the method 400 may execute a shipper selection algorithm to select a shipper. At 420, the method 400 may optionally resume back to the original process.

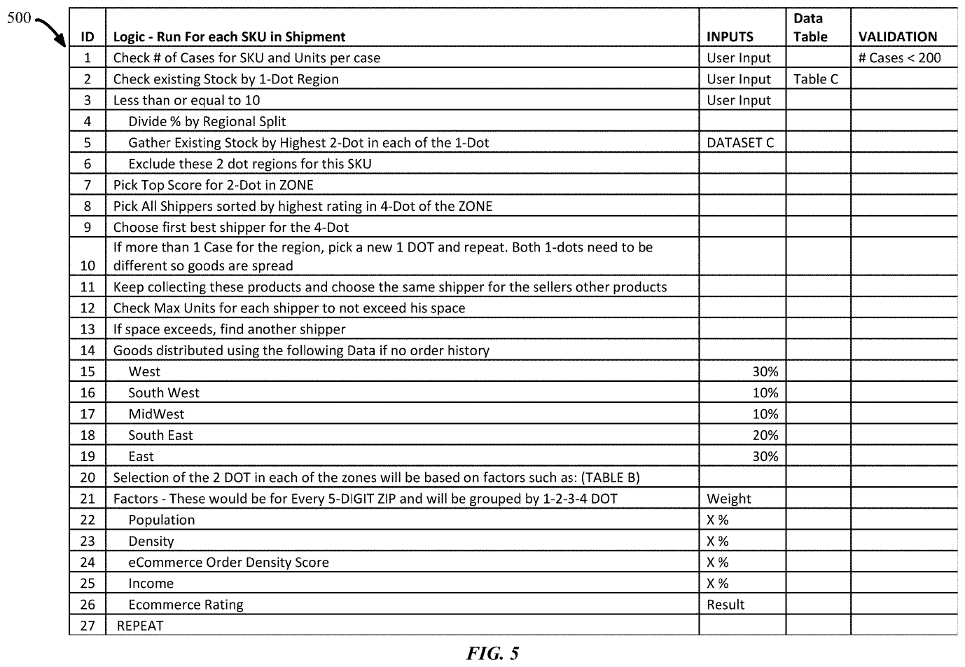

FIG. 5 illustrates an example of an algorithm 500 for micro warehouse distribution. The algorithm 500 may be utilized for distribution center. For hybrid (i.e., micro warehouse and distribution center), goods may be distributed to distribution center, and then to nearby micro warehouses. Sellers may select percentage of inventory to send to the micro warehouses. Additional carrier labels may be generated for the boxes sent from the distribution center to the micro warehouses. For example, if a seller decided to ship 10 boxes of merchandise. The distribution may be performed using the algorithm 500. Assuming no order history, if 3 boxes are allocated for West, 1 box for Southwest, 1 box for Midwest, 2 boxes for Southeast, and 3 boxes for East. If the seller selects 60% distribution center and 40% micro warehouses, the distribution center will retain 6 boxes and distribute 4 boxes to the micro warehouses. Four carrier labels will be generated for the distribution center to handle the delivery to the micro warehouses. Micro warehouses in East, West, and Southeast may be selected based on aspects of the present disclosure. In an aspect, products stored in the distribution center may be charged a storage fee while products stored in the micro warehouses may not be charged.

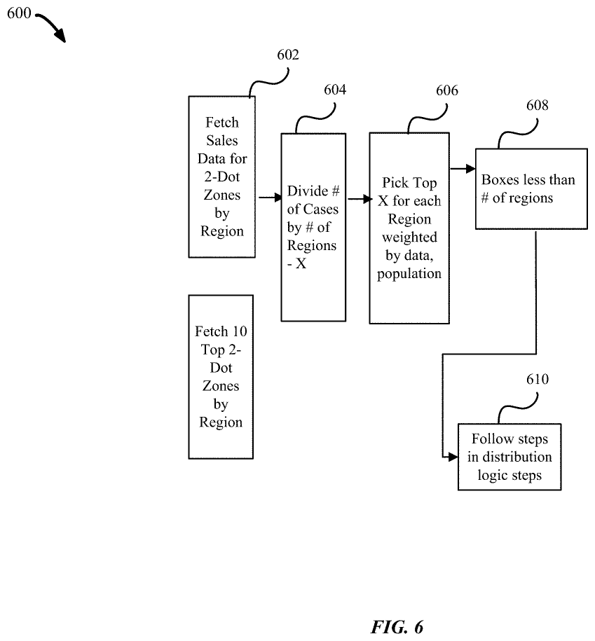

Turning to FIG. 6, and referencing FIGS. 1 and 2, in certain aspects, a method 600 for distribution may, at 602 (when sales history is available), obtain sales data for one or more 2 dot zones (locales with same first two digits zip codes) for one or more regions (e.g., Mid-west region, West Coast region, Mid-Atlantic region). Next, at 604, the method 600 may divide the number of cases by the number of regions. At 606, the method 600 may select a number of sellers for each region, based on performance, reviews, and/or other metrics. The selection may be weighted by data, population, or other variables. At 608, if the number of boxes is less than the number of regions, the method 600 may proceed to step 610 to follow distribution logic steps as follows.

| ID | Logic | INPUTS | Validation |
|---|---|---|---|
| 1 | Check # of Cases for SKU and Units | User Input | # cases |
| | per case | | under 200 |
| 2 | Check existing Stock by 1-Dot Region | | |
| 3 | Less than or equal to 10 | User Input | |
| 4 | Divide % by Regional Split | | |
| 5 | Gather Existing Stock by 1-Dot | DATASET C | |
| 6 | Do not send to those 1 dot regions | | |
| 7 | Pick Top Score for 1-Dot in ZONE | | |
| 8 | Pick All Shippers sorted by rating in | | |
| | 4-Dot of the ZONE | | |
| 9 | Choose first best for the 4-Dot | | |
| 10 | If more than 1 Case for the region, | | |
| | pick second 1-DOT. | | |
| | Both 1-dots need to be different | | |
| 11 | Keep collecting these products and | | |
| | choose the same shipper for the sellers | | |
| | other products | | |
| 12 | Check Max Units for each shipper to | | |
| | not exceed his space | | |
| 13 | If space exceeds, find another shipper | | |

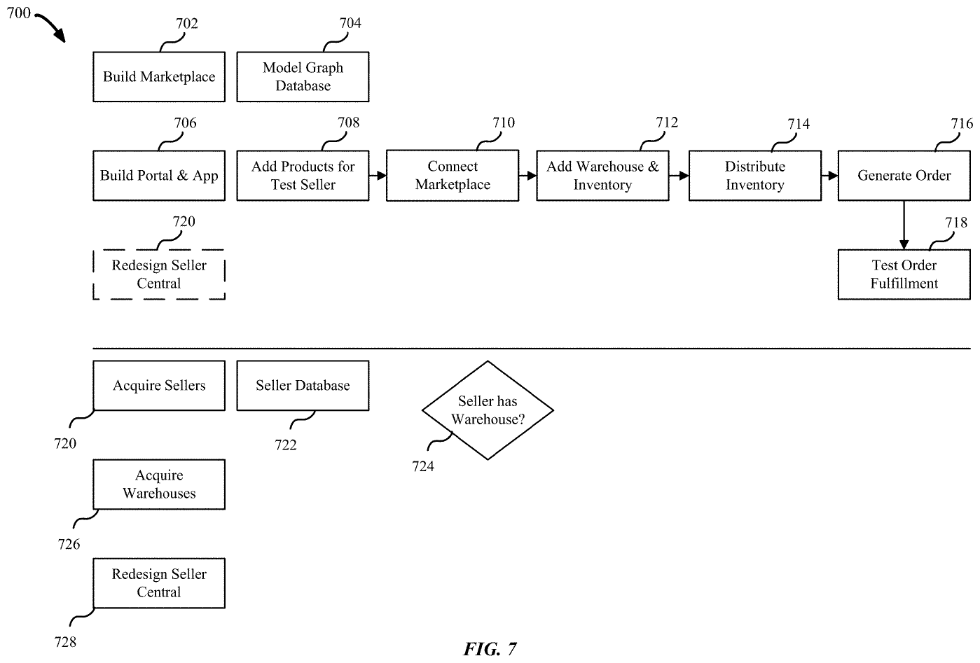

Turning to FIG. 7, an example of a method 700 for deploying micro warehouses. At 702, the method 700 may include building a marketplace. At, 704 the method 700 may implement model graph databases to predict consumer purchase preferences (e.g., Neo4J graph database). At 706, the method 700 may including building portal and/or app for deploying micro warehouses. At 708, the method 700 may add products for test sellers. At 710, the method 700 may connect market places (e.g., Amazon™, Etsy™, eBay™, etc.). At 712, the method 700 may add warehouse and/or inventory. At 714, the method 700 may distribute the inventory. At 716, the method 700 may generate test orders. At 718, the method 700 may fulfill test orders. At 720, the method 700 may optionally redesign seller central.

At 720, the method 700 may recruit sellers. At 722, the method 700 may construct seller database. At 724, the method 700 may determine whether the seller has a warehouse. At 726, the method 700 may acquire a warehouse. At 728, the method 700 may optionally redesign the seller central.

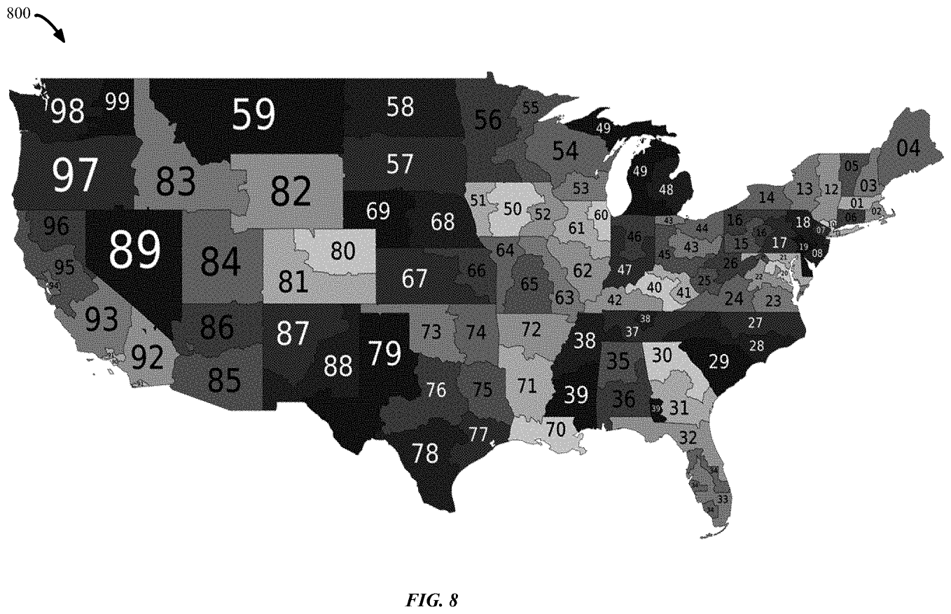

FIG. 8 illustrates an example of a map 800 showing locations grouped by the first two digits of the zip codes of the United States (2-Dot). A zip code has five digits (referred to as 5-Dot), such as 08852. The 4-Dot representation for the zip code 08852 is 0885. The 3-Dot representation is 088. The 2-Dot representation is 08. And the 1-Dot representation is 0. For example, the state of Idaho has zip codes that begin with “83.” The state of California has zip codes that begin with “90,” “91,” “92,” “93,” “94,” “95,” or “96.” The map 800 may be used to compute delivery distances, carrier charges, seller distributions, etc.

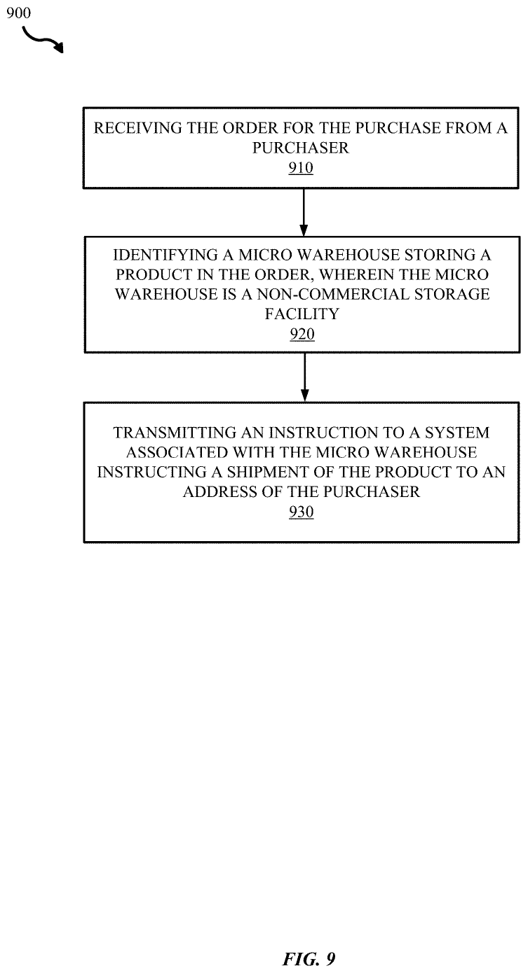

Turning to FIG. 9, an example of a method 900 for processing a purchase order may be performed by various components including, for example, one or more of the following: the processor 122, memory 124, the communication component 130, the order component 132, the distribution algorithm 140, the shipping algorithm 142, and/or one or more of the sub-routines.

At block 910, the method 900 may receive the order for the purchase from a purchaser. For example, the communication component 130, the processor 122, and/or the memory 124 may receive the purchase order 118 for the purchase from the customer 114.

At block 920, the method 900 may identify a micro warehouse storing a product in the order, wherein the micro warehouse is a non-commercial storage facility. For example, the order component 132, the distribution algorithm 140, the processor 122, and/or the memory 124 may identify the first micro warehouse 104 that stores a product in the order.

At block 930, the method 900 may transmit an instruction to a system associated with the micro warehouse instructing a shipment of the product to an address of the purchaser. For example, the communication component 130, the order component 132, the distribution algorithm 140, the shipping algorithm 142, the processor 122, and/or the memory 124 may transmit an indication 119 to a system associated with the first micro warehouse 104 instructing a shipment of the product to an address of the destination 102.

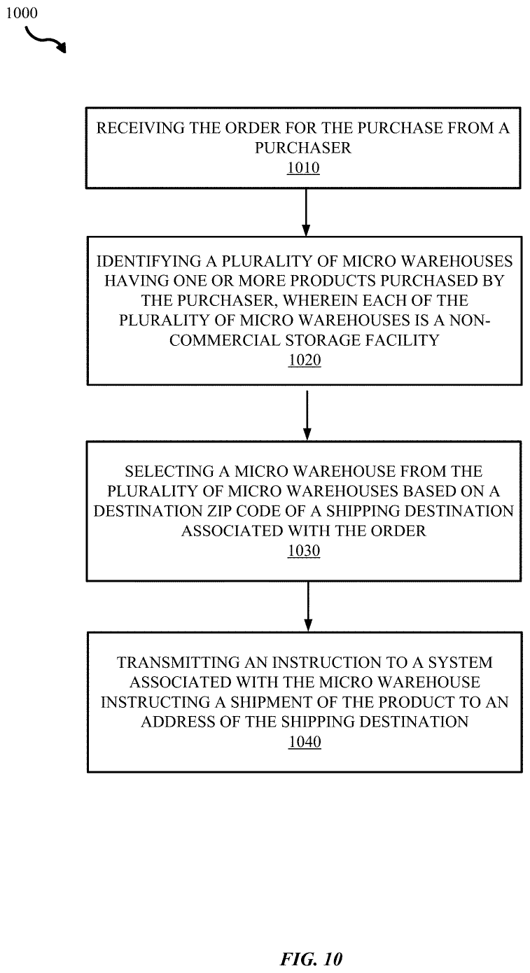

Turning to FIG. 10, an example of a method 1000 for processing a purchase order may be implemented via various components including, for example, one or more of the following: processor 122, memory 124, communication component 130, order component 132, distribution algorithm 140, shipping algorithm 142, and/or one or more sub-routines.

At block 1010, the method 1000 may receive the order for the purchase from a purchaser. For example, communication component 130, processor 122, and/or memory 124 may receive the purchase order 118 for the purchase from customer 114.

At block 1020, the method 1000 may identify a micro warehouse storing a product identified in the order, wherein the micro warehouse may be a non-commercial storage facility. For example, the order component 132, the distribution algorithm 140, the processor 122, and/or the memory 124 may identify the first micro warehouse 104 that stores a product associated with the order.

At block 1030, the method 1000 may select a micro warehouse from the plurality of micro warehouses based on a destination zip code of a shipping destination associated with the order. For example, the shipping algorithm 142, the processor 122, and/or the memory 124 may select a micro warehouse from the plurality of micro warehouses based on a destination zip code of a shipping destination associated with the order.

At block 1040, the method 1000 may transmit an instruction to a system associated with the micro warehouse instructing a shipment of the product to an address of the purchaser. For example, the communication component 130, the order component 132, the distribution algorithm 140, the shipping algorithm 142, the processor 122, and/or the memory 124 may transmit an indication 119 to a system associated with the first micro warehouse 104 instructing shipment of the product to an address of the destination 102.

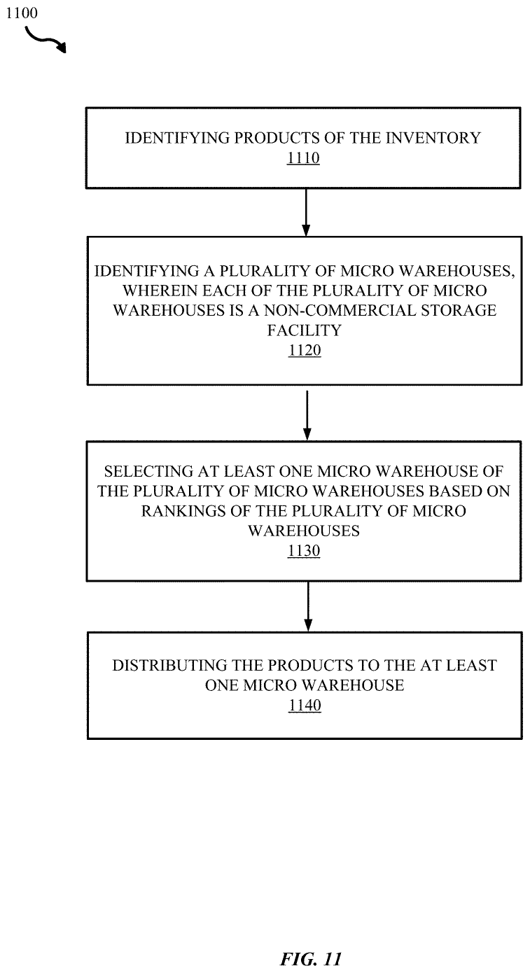

Turning to FIG. 11, an example of a method 1100 for distributing products may be implemented via various components including, for example, one or more of the following: processor 122, memory 124, communication component 130, order component 132, distribution algorithm 140, shipping algorithm 142, and/or one or more sub-routines.

At block 1110, the method 1100 may identify products of the inventory. For example, the distribution algorithm 140, the processor 122, and/or the memory 124 may identify products of the inventory.

At block 1120, the method 1100 may identify a plurality of micro warehouses, wherein each of the plurality of micro warehouses may be a non-commercial storage facility. For example, the order component 132, the distribution algorithm 140, the shipping algorithm 142, the processor 122, and/or the memory 124 may identify a plurality of micro warehouses, wherein each of the plurality of micro warehouses may be a non-commercial storage facility.

At block 1130, the method 1100 may select at least one micro warehouse of the plurality of micro warehouses based on rankings (based on, e.g., cut-off timing, shipment, damage rate, loss rate, on time shipment rate, on time acknowledgement rate, cost rating, total space, used space, and/or available space) of the plurality of micro warehouses. For example, the distribution algorithm 140, the processor 122, and/or the memory 124 may select at least one micro warehouse of the plurality of micro warehouses based on rankings of the plurality of micro warehouses.

At block 1140, the method 1100 may distribute the products to the at least one micro warehouse. For example, the communication component 130, the order component 132, the distribution algorithm 140, the shipping algorithm 142, the processor 122, and/or the memory 124 may distribute the products to the at least one micro warehouse.

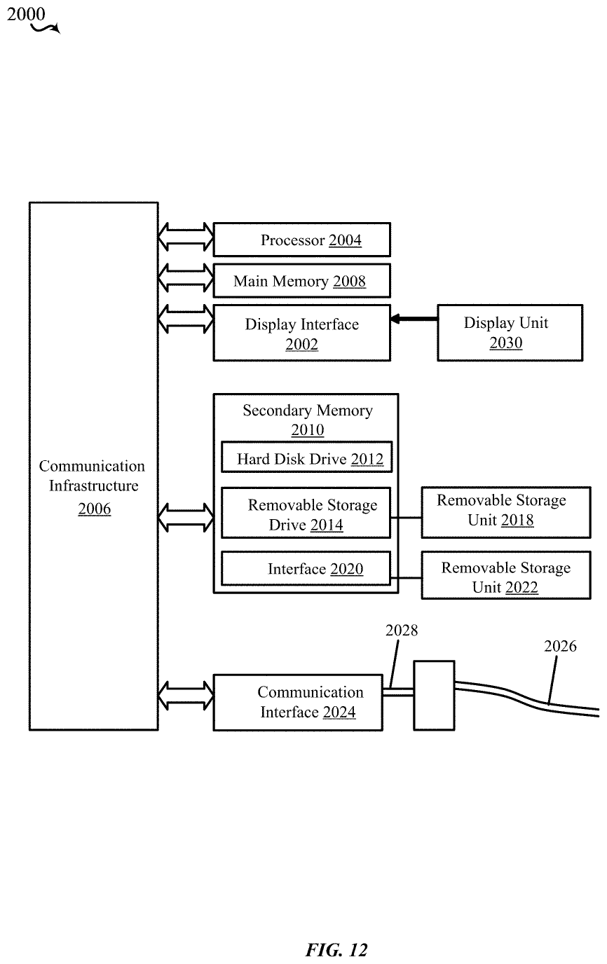

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. For example, the server 120 may be implemented as the computer system 2000. An example of such the computer system 2000 is shown in FIG. 12.

The computer system 2000 includes one or more processors, such as processor 2004. The processor 2004 is connected to a communication infrastructure 2006 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 2000 may include a display interface 2002 that forwards graphics, text, and other data from the communication infrastructure 2006 (or from a frame buffer not shown) for display on a display unit 2030. Computer system 2000 also includes a main memory 2008, preferably random access memory (RAM), and may also include a secondary memory 2010. The secondary memory 2010 may include, for example, a hard disk drive 2012, and/or a removable storage drive 2014, representing a floppy disk drive, a magnetic tape drive, an optical disk drive, a universal serial bus (USB) flash drive, etc. The removable storage drive 2014 reads from and/or writes to a removable storage unit 2018 in a well-known manner. Removable storage unit 2018 represents a floppy disk, magnetic tape, optical disk, USB flash drive etc., which is read by and written to removable storage drive 2014. As will be appreciated, the removable storage unit 2018 includes a computer usable storage medium having stored therein computer software and/or data.

Alternative aspects of the present disclosures may include secondary memory 2010 and may include other similar devices for allowing computer programs or other instructions to be loaded into computer system 2000. Such devices may include, for example, a removable storage unit 2022 and an interface 2020. Examples of such may include a program cartridge and cartridge interface (such as that found in video game devices), a removable memory chip (such as an erasable programmable read only memory (EPROM), or programmable read only memory (PROM)) and associated socket, and the removable storage unit 2022 and interface 2020, which allow software and data to be transferred from the removable storage unit 2022 to computer system 2000.

Computer system 2000 may also include a communications interface 2024. Communications interface 2024 allows software and data to be transferred between computer system 2000 and external devices. Examples of communications interface 2024 may include a modem, a network interface (such as an Ethernet card), a communications port, a Personal Computer Memory Card International Association (PCMCIA) slot and card, etc. Software and data transferred via communications interface 2024 are in the form of signals 2028, which may be electronic, electromagnetic, optical or other signals capable of being received by communications interface 2024. These signals 2028 are provided to communications interface 2024 via a communications path (e.g., channel) 2026. This path 2026 carries signals 2028 and may be implemented using wire or cable, fiber optics, a telephone line, a cellular link, an RF link and/or other communications channels. In this document, the terms “computer program medium” and “computer usable medium” are used to refer generally to media such as a removable storage unit 2018, a hard disk installed in hard disk drive 2012, and signals 2028. These computer program products provide software to the computer system 2000. Aspects of the present disclosures are directed to such computer program products.

Computer programs (also referred to as computer control logic) are stored in main memory 2008 and/or secondary memory 2010. Computer programs may also be received via communications interface 2024. Such computer programs, when executed, enable the computer system 2000 to perform the features in accordance with aspects of the present disclosures, as discussed herein. In particular, the computer programs, when executed, enable the processor 2004 to perform the features in accordance with aspects of the present disclosures. Accordingly, such computer programs represent controllers of the computer system 2000.

In an aspect of the present disclosures where the method is implemented using software, the software may be stored in a computer program product and loaded into computer system 2000 using removable storage drive 2014, hard disk drive 2012, or the interface 2020. The control logic (software), when executed by the processor 2004, causes the processor 2004 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

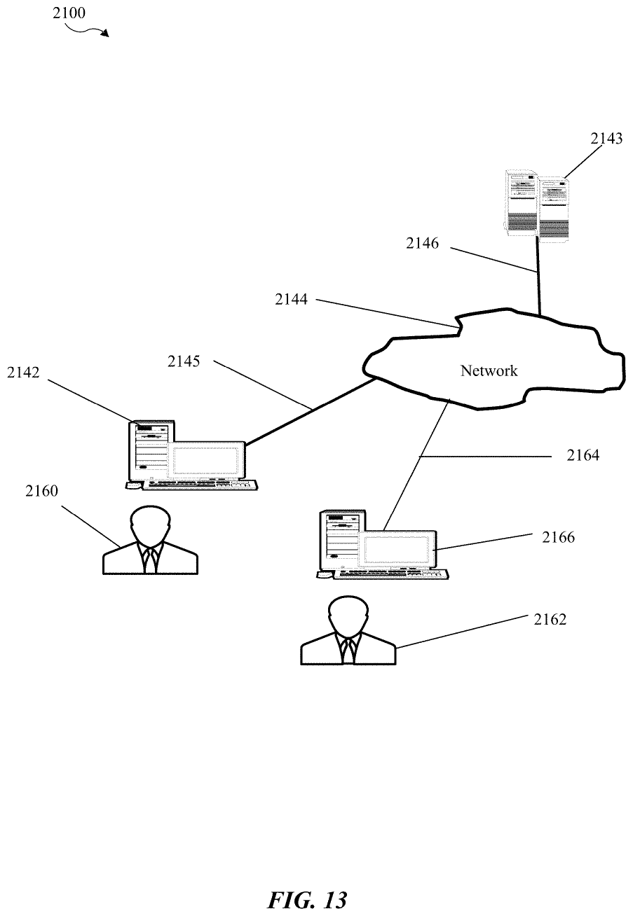

FIG. 13 is a block diagram of various example system components, in accordance with an aspect of the present disclosure. FIG. 13 shows a communication system 2100 usable in accordance with the present disclosure. The communication system 2100 includes one or more accessors 2160, 2162 (also referred to interchangeably herein as one or more “users”) and one or more terminals 2142, 2166. In one aspect, data for use in accordance with aspects of the present disclosure is, for example, input and/or accessed by the one or more accessors 2160, 2162 via the one or more terminals 2142, 2166, such as personal computers (PCs), minicomputers, mainframe computers, microcomputers, telephonic devices, or wireless devices, such as personal digital assistants (“PDAs”) or a hand-held wireless devices coupled to a server 2143, such as a PC, minicomputer, mainframe computer, microcomputer, or other device having a processor and a repository for data and/or connection to a repository for data, via, for example, a network 2144, such as the Internet or an intranet, and couplings 2145, 2146, 2164. The couplings 2145, 2146, 2164 include, for example, wired, wireless, or fiberoptic links. In another example variation, the method and system in accordance with aspects of the present disclosure operate in a stand-alone environment, such as on a single terminal.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method of fulfilling an order for a purchase, comprising:
receiving the order for the purchase from a purchaser;
identifying a micro warehouse storing a product in the order, wherein the micro warehouse is a non-commercial storage facility; and
transmitting an instruction to a system associated with the micro warehouse instructing a shipment of the product to an address of the purchaser.

2. The method of claim 1, further comprising displaying the product for purchase on a remote device.

3. The method of claim 1, wherein identifying the micro warehouse comprises:
identifying a plurality of micro warehouses storing the product in the order; and
identifying the micro warehouse based on locations of the plurality of micro warehouses and the address of the purchaser.

4. The method of claim 3, wherein identifying the micro warehouse based on the locations of the plurality of micro warehouses comprises identifying the micro warehouse based on a plurality of postal codes associated with the plurality of micro warehouses.

5. The method of claim 4, wherein identifying the micro warehouse based on the plurality of postal codes comprises:
identifying a first subset of the plurality of micro warehouses based on a first subset of digits of each of the plurality of postal codes; and
identifying the micro warehouse from the first subset of the plurality of micro warehouses based on a second subset of digits of each of the plurality of postal codes.

6. The method of claim 1, wherein the micro warehouse is a default micro warehouse.

7. The method of claim 1, further comprising transmitting a shipping label to the system for shipping the product from a shipping address of the micro warehouse to the address of the purchaser.

8. A server for fulfilling an order for a purchase, comprising:
a memory; and
one or more processors communicatively coupled with the memory and configured to:
receive the order for the purchase from a purchaser;
identify a micro warehouse storing a product in the order, wherein the micro warehouse is a non-commercial storage facility; and
transmit an instruction to a system associated with the micro warehouse instructing a shipment of the product to an address of the purchaser.

9. The server of claim 8, wherein the one or more processors are further configured to display the product for purchase on a remote device.

10. The server of claim 8, wherein identifying the micro warehouse comprises:
identifying a plurality of micro warehouses storing the product in the order; and
identifying the micro warehouse based on locations of the plurality of micro warehouses and the address of the purchaser.

11. The server of claim 10, wherein identifying the micro warehouse based on the locations of the plurality of micro warehouses comprises identifying the micro warehouse based on a plurality of postal codes associated with the plurality of micro warehouses.

12. The server of claim 11, wherein identifying the micro warehouse based on the plurality of postal codes comprises:
identifying a first subset of the plurality of micro warehouses based on a first subset of digits of each of the plurality of postal codes; and
identifying the micro warehouse from the first subset of the plurality of micro warehouses based on a second subset of digits of each of the plurality of postal codes.

13. The server of claim 8, wherein the one or more processors are further configured to transmit a shipping label to the system for shipping the product from a shipping address of the micro warehouse to the address of the purchaser.

14. A non-transitory computer readable medium having instructions stored therein that, when executed by one or more processors of a server, cause the one or more processors to:
receive an order for a purchase from a purchaser;
identify a micro warehouse storing a product in the order, wherein the micro warehouse is a non-commercial storage facility; and
transmit an instruction to a system associated with the micro warehouse instructing a shipment of the product to an address of the purchaser.

15. The non-transitory computer readable medium of claim 14, further comprises instructions that cause the one or more processors to display the product for purchase on a remote device.

16. The non-transitory computer readable medium of claim 14, wherein the instructions for identifying the micro warehouse comprises instructions for:
identifying a plurality of micro warehouses storing the product in the order; and
identifying the micro warehouse based on locations of the plurality of micro warehouses and the address of the purchaser.

17. The non-transitory computer readable medium of claim 16, wherein the instructions for identifying the micro warehouse based on the locations of the plurality of micro warehouses comprises instructions for identifying the micro warehouse based on a plurality of postal codes associated with the plurality of micro warehouses.

18. The non-transitory computer readable medium of claim 17, wherein the instructions for identifying the micro warehouse based on the plurality of postal codes comprises instructions for:
identifying a first subset of the plurality of micro warehouses based on a first subset of digits of each of the plurality of postal codes; and
identifying the micro warehouse from the first subset of the plurality of micro warehouses based on a second subset of digits of each of the plurality of postal codes.

19. The non-transitory computer readable medium of claim 14, wherein the micro warehouse is a default micro warehouse.

20. The non-transitory computer readable medium of claim 14, further comprises instructions that cause the one or more processors to transmit a shipping label to the system for shipping the product from a shipping address of the micro warehouse to the address of the purchaser.
